(19) United States
(12) Patent Application Publication
(10) Pub. No.: US 2013/0283186 A1
(43) Pub. Date: Oct. 24, 2013

(54) FILE UPLOADING METHOD AND ELECTRONIC DEVICE FOR FAST FILE LOCATION

(71) Applicant: ZHONG-LIN XU, Shenzhen City (CN)

(72) Inventor: ZHONG-LIN XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/559,807

(22) Filed: Jul. 27, 2012

(30) Foreign Application Priority Data
Apr. 23, 2012 (CN) 201210119701.8

(51) Int. Cl. G06F 17/30; G06F 3/01

(52) U.S. Cl. 715/748

(57) ABSTRACT

A computerized file uploading method uploads files from an electronic device to a target device. When a target file stored in the electronic device is needed to be uploaded to the target device, a user is notified to input attribute information of the target file. Files that match with the attribute information inputted by the user are searched from a storage of electronic device, and are displayed through a display device of the electronic device for the user to select the target file to be uploaded. When the target file is selected, the target file is uploaded to the target device through a connection between the electronic device and the target device.

### BACKGROUND

1. Technical Field

Embodiments of the present disclosure relate to file management technologies, and particularly to a file uploading method and an electronic device having a function of quickly locating a file to be uploaded.

2. Description of Related Art

Many electronic devices such as tablet personal computers and smart phones may be used to store different types of files, such as photos, videos, and various text files. Users need to upload some of the files from an electronic device to other target devices, such as website terminals, web servers, and other similar devices. However, since a great number of files may be stored in the electronic device, the user cannot quickly find the file to be uploaded, which is time consuming and inconvenient during the file uploading process. Therefore, there is a room for improvement in the art.

### BRIEF DESCRIPTION OF THE DRAWINGS

FIG. 1 is a schematic block diagram illustrating one embodiment of an electronic device including a file uploading system for uploading files from the electronic device to a target device.

FIG. 2 illustrates a schematic diagram of a user interface used for inputting attribute information of a target file to be uploaded to the target device.

FIG. 3 shows a flowchart of one embodiment of a file uploading method implemented by the electronic device to upload the target file to the target device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

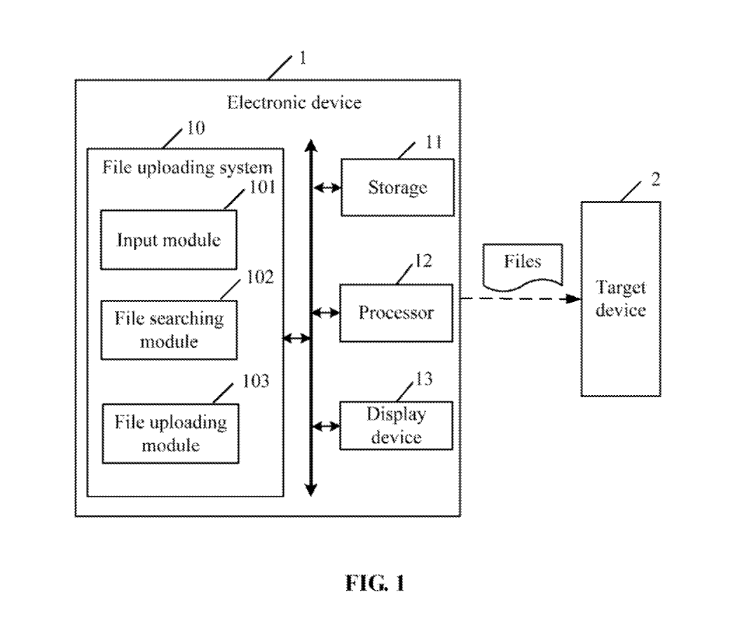

FIG. 1 is a schematic block diagram illustrating one embodiment of an electronic device 1. The electronic device 1 includes a file uploading system 10 used for uploading files from the electronic device 1 to a target device 2. In the embodiment, the electronic device 1 may be, for example, a smart phone, a personal digital assistant, a mobile Internet device, a desktop computer, a portable computer, or other similar devices that can be used to store various files such as text files, photos, and videos. The target device 2 may be a website terminal, a web server, or any other device that can receive files uploaded from the electronic device 1. The electronic device 1 can communicate with the target device 2 through any kind of connection, such as a wireless or wired network, BLUETOOTH, or a data cable connected between the electronic device 1 and the target device 2.

The electronic device 1 further includes a storage 11, a processor 12, and a display device 13. The storage 11 stores a plurality of files. The File uploading system 10 may include a plurality of programs in the form of one or more computerized instructions stored in the storage 11 and executed by the processor 12 to perform operations of the electronic device 1. In the embodiment, the File uploading system 10 includes an input module 101, a file searching module 102, and a file uploading module 103. FIG. 1 shows one example of the electronic device 1, and the electronic device 1 can include more or fewer components than those shown in the embodiment, or have a different configuration of the components.

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The input module 101 notifies a user to input attribute information of a target file stored in the electronic device 1 when the target file is needed to be uploaded from the electronic device 1 to the target device 2. In the embodiment, the attribute information of the target file includes a directory of the electronic device 1 where the target file is located, a type (e.g., music, photo, video, and text file) and a format (e.g., JPEG, MP3, TIF, and, AVI) of the target file, and time information when the target file is established or modified. The directory refers to a virtual container within a digital file system, in which groups of computer files and possibly other sub-directories can be kept and organized. The time information may be a determined time or an estimated time period.

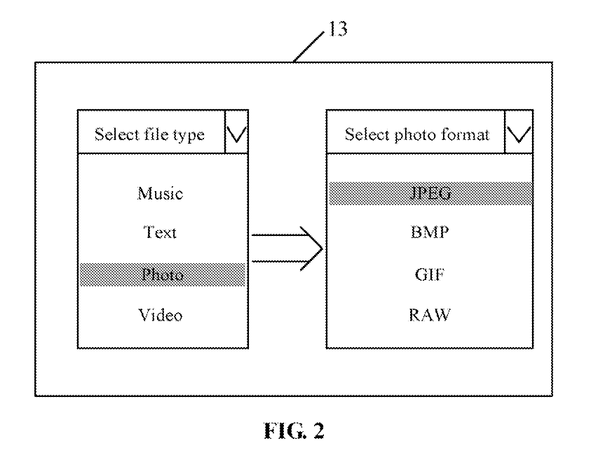

In one embodiment, the input module 101 may create an input interface for the user to input the attribute information of the target file. In one example, as shown in FIG. 2, the user may first input the type of the target file, and then select the format of the target file, through the interface 13 of FIG. 2. Accordingly, the input module 101 may create other similar interface to receive the other attribute information (e.g., the directory and the time information) of the target file.

The file searching module 102 searches the storage 11 of the electronic device 1 for files that match with the attribute information inputted by the user, and displays the searched files through the display device 13. In one embodiment, the file searching module 102 first searches the directory inputted by the user for a first group of files that match with the type of the target file. Then, the file searching module 102 searches the first group of files for a second group of files that match with the format of the target file. Additionally, the file searching module 102 searches the second group of files for a third group of files that match with the time information, where the third group of files includes all files matching with the attribute information of the target file.

The file uploading module 103 uploads the target file selected by the user to the target device 2 through the connection between the electronic device 1 and the target device 2.

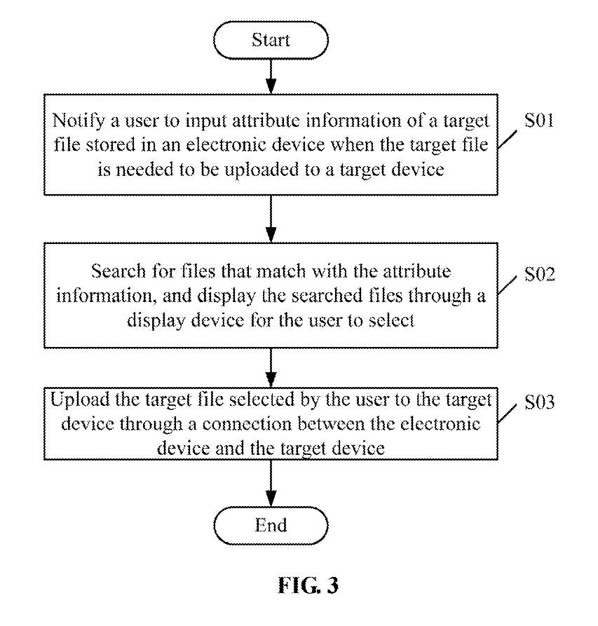

FIG. 3 shows a flowchart of one embodiment of a file uploading method implemented by the electronic device 1 to upload the target file to the target device 2. Depending on the embodiment, additional steps may be added, others removed, and the ordering of the steps may be changed.

In step S01, when the target file stored in the electronic device 1 is needed to be uploaded to the target device 2, the input module 101 notifies a user to input attribute information of the target file.

In step S02, the file searching module 102 searches the storage 11 of the electronic device 1 for files that match with the attribute information inputted by the user, and displays the searched files through the display device 13 for the user to select the target file to be uploaded.

In step S03, the file uploading module 103 uploads the target file selected by the user to the target device 2 through the connection between the electronic device 1 and the target device 2.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized file uploading method for uploading files from an electronic device to a target device, the method comprising:
notifying a user to input attribute information of a target file, when the target file stored in the electronic device is needed to be uploaded to the target device;
searching a storage of the electronic device for files that match with the attribute information inputted by the user, and displaying the searched files through a display device of the electronic device for the user to select; and
uploading the target file selected by the user to the target device through a connection between the electronic device and the target device.

2. The method according to claim 1, wherein the notifying step comprises:
creating an input interface for the user to input the attribute information of the target file.

3. The method according to claim 1, wherein the attribute information of the target file comprise at least one selected from a group consisting of a directory of the electronic device where the target file is located, a type and a format of the target file, and time information when the target file is established or modified.

4. The method according to claim 3, wherein the searching step comprises:
searching the directory inputted by the user for a first group of files that match with the type of the target file;
searching the first group of files for a second group of files that match with the format of the target file; and
searching the second group of files for a third group of files that match with the time information.

5. The method according to claim 1, wherein the connection between the electronic device and the target device is a wireless or wired network, BLUETOOTH, or a data cable connected between the electronic device and the target device.

6. An electronic device communicating with a target device, the electronic device comprising:
a display device;
a storage storing a plurality of files;
a processor; and
one or more programs stored in the storage and executed by the processor, the one or more programs comprising:
an input module that notifies a user to input attribute information of a target file when the target file stored in the electronic device is needed to be uploaded to the target device;
a file searching module that searches the storage for files that match with the attribute information inputted by the user, and displays the searched files through the display device for the user to select; and
a file uploading module that uploads the target file selected by the user to the target device through a connection between the electronic device and the target device.

7. The electronic device according to claim 6, wherein the input module further creates an input interface for the user to input the attribute information of the target file.

8. The electronic device according to claim 6, wherein the attribute information of the target file comprise at least one selected from a group consisting of a directory of the electronic device where the target file is located, a type and a format of the target file, and time information when the target file is established or modified.

9. The electronic device according to claim 8, wherein the file searching module searches the files matching with the attribute information by:
searching the directory inputted by the user for a first group of files that match with the type of the target file;
searching the first group of files for a second group of files that match with the format of the target file; and
searching the second group of files for a third group of files that match with the time information.

10. The electronic device according to claim 6, wherein the connection between the electronic device and the target device is a wireless or wired network, BLUETOOTH, or a data cable connected between the electronic device and the target device.
